(19) United States
(12) Patent Application Publication
(10) Pub. No.: US 2009/0000643 A1
(43) Pub. Date: Jan. 1, 2009

(54) Cleaning article and its use

(75) Inventors: Annette Schaadt, Augsburg (DE); Mirko Peczynski, Bergkirchen (DE); Wolfgang Schedl, Augsburg (DE); Marc Hunger, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 12/214,058

(22) Filed: Jun. 16, 2008

(30) Foreign Application Priority Data
Jun. 14, 2007 (DE) 102007028039.6-26

(51) Int. Cl. B08B 1/00; D04H 13/00

(52) U.S. Cl. 134/6; 428/219

(57) ABSTRACT

A cleaning article for moist or wet cleaning is provided. The cleaning article is a nonwoven with a mechanically stable three-dimensional structure, a weight per unit area of 50-300 g/m² and a thickness of 2-6 mm. The nonwoven is consolidated mechanically, chemically or thermally. The nonwoven has a maximum tensile force, in at least one direction, of 100-300 N/50 mm, a maximum tensile force elongation in a longitudinal direction of, at most, 35% and in a transverse direction of, at most, 70%, a water absorptive capacity of 2- to 10-times a weight of the nonwoven. The nonwoven is soft, has a three-dimensional structure with a plurality of cavities. The nonwoven is either a binder-bound nonwoven, a bi-component non-woven or a sandwich nonwoven.

### FIELD OF THE INVENTION

The invention under consideration concerns a cleaning article, in particular, for a moist or wet cleaning, comprising a nonwoven, and its use for cleaning human skin or household surfaces or for cleaning surfaces in industrial applications.

### BACKGROUND OF THE INVENTION

Nonwovens, which are particularly absorbent for liquids, are particularly desired for moist or wet cleaning, especially, in the area of use as a cleaning article. Nonwovens used as cleaning articles should be particularly durable and should withstand mechanical stresses in use and in the subsequent cleaning, for example, under the conditions of mechanical washing. Moreover, the cleaning articles should be particularly suitable for dirt absorption.

An easy cleaning and washability of the cleaning articles is especially important from a hygienic perspective in the area of cleaning articles that are repeatedly used. A soft embodiment of a nonwoven provides for a pleasant feel and a gentle cleaning of sensitive surfaces, such as the human skin or scratch-sensitive surfaces and is therefore also desirable.

### SUMMARY OF THE INVENTION

The goal of the invention under consideration is to provide nonwoven cleaning articles that have a mechanically stable, three-dimensional (3D) structure, which are simultaneously particularly soft, absorptive and receptive for moisture, wetness, and dirt and are very washable.

The cleaning articles in accordance with the invention comprise nonwovens consolidated by means of a mechanical, thermal, and/or chemical bonding. In addition, the nonwoven has a three-dimensional structure with pores or cavities for taking up dirt.

The nonwoven comprises, as an alternative, 20-90 wt % cotton and/or viscose fibers, 5-50 wt % plastic fibers, in particular, polyester fibers, and/or 5-35 wt % polyolefin fibers, in particular, polypropylene fibers, and is impregnated with 2-20 wt % of a polymeric binder, selected from latex suspensions, whose solids fraction is 1-60 wt %. This binder-bound nonwoven can be thermally re-formed and has a particularly good structural stability and sufficient softness, a special water absorbency, and washability.

Alternatively to the aforementioned binder-bound nonwoven, a bi-component nonwoven can be provided that comprises 5-50 wt % bi-component fibers, in particular, core-jacket fibers consisting of a higher-melting core and a lower-melting jacket, with jacket fibers of polyester with a fraction of 5-30 wt % and cotton and/or viscose fibers with a fraction of 20-90 wt %, preferably, 50-85 wt %, and/or polyolefin fibers, preferably, polypropylene fibers, with a fraction of 5-20, preferably, 5-50 wt %.

As a further alternative, a sandwich nonwoven can be provided, which is built in at least three layers, wherein at least one inside layer is structured to be equal to or more than 50 wt % plastic fibers and wherein the outside layers are structured to be more than 50 wt % cotton and/or viscose fibers, and wherein the sandwich nonwoven is, if necessary, impregnated with 2-20 wt % of a polymeric binder selected from latex suspensions whose solids fraction is 1-60 wt % (binder-bound sandwich nonwoven). The sandwich variants are particularly stable structurally due to the high fraction of plastic fibers in the middle layer, and they are particularly soft and absorbent due to the high natural fiber fraction.

The nonwoven of the cleaning article of all three alternatives has a maximum tensile force in at least one direction of 100-300 N/50 mm, a maximum tensile force elongation in the longitudinal direction of at most 35%, and in the transverse direction of at most 70% and a water absorption capacity of 2- to 10-fold the nonwoven weight.

The nonwoven of the cleaning article of all three alternatives is also particularly soft—that is, it has low fiber rigidity and therefore provides for a pleasant feel and is especially suitable for gentle cleaning of sensitive surfaces.

In a preferred embodiment of the cleaning article, the nonwoven is made of staple fibers, which are laid out to dry, in particular, by means of carding machines, and are mechanically consolidated, especially by means of needles, and thermally consolidated and/or chemically consolidated by means of a binder and are structured by deep-drawing in an embossing calender.

Thermally consolidated nonwovens are generally particularly soft. However, fibers can be loosened from the surface when in use.

Binder-bound nonwovens are basically somewhat less soft, but are, on the other hand, very stable with regard to the loosening of fibers from the surface when in use.

A subsequent embossing by deep-drawing in an embossing calender makes possible the formation of a stable three-dimensional structure with so-called pick-up pores or cavities, which are particularly suitable to take up dirt while simultaneously retaining the softness and absorbency of the nonwoven.

The combination of the aforementioned material compositions together with the method leads to a nonwoven that has a uniform structure due to a uniform shaping in all directions, in which flat, melted partial areas are not formed either in the peaks or in the valleys of the structure. Consequently, a thermal shaping without plasticizing takes place.

In selecting a chemical consolidation by means of a binder, the binder is advantageously selected from nitrile butadiene rubber (NBR) latex suspensions.

The plastic fibers for an inside layer of a sandwich nonwoven structured in at least three layers are selected from thermoplastics, such as polyolefins, polyesters, polyacrylonitriles, polyamides, polyimides, polycarbonates, and/or their copolymers and/or their mixtures, preferably selected from polypropylene and from polyethylene terephthalate.

In a preferred embodiment of the cleaning article, the binder-bound nonwoven comprises 60-65 wt % viscose fibers, 20-30 wt % polyethylene terephthalate fibers, and/or 10-20 wt % polypropylene fibers and is impregnated with nitrile butadiene rubber (NBR) latex as a binder, whose solids fraction is 10-20 wt %.

Alternatively to the binder-bound nonwoven, the bi-component nonwoven advantageously comprises bi-component fibers of polyethylene terephthalate with a fraction of 15-20 wt % and also viscose fibers with a fraction of 60-70 wt % and polypropylene fibers with a fraction of 10-20 wt %.

The sandwich nonwoven structure with at least three layers preferably has at least one inside layer with 30-70 wt % polyolefin fibers, in particular, polypropylene fibers, and 70-30 wt % polyester fibers, in particular, polyethylene terephthalate fibers, or it has, preferably as at least one inside layer, 30-40 wt % polyolefin fibers, in particular, polypropylene fibers, and 25-50 wt % polyester fibers, in particular, polyethylene terephthalate fibers, and 20-30 wt % viscose fibers. In the sandwich nonwoven structured with at least three layers, the outside layers are preferably equal to or more than 85 wt % viscose fibers and equal to or less than 15 wt % polyolefin fibers, in particular, polypropylene fibers.

The cleaning articles in accordance with the invention are preferably wash-stable at temperatures to 60° C.

As a result of their aforementioned characteristics, the cleaning articles in accordance with the invention are preferred for moist or wet cleaning and can be used advantageously to clean human skin or even sensitive household surfaces or in industrial applications. The cleaning articles in accordance with the invention are therefore advantageously used as a cleaning cloth or in a wiping mop.

### BRIEF DESCRIPTION OF THE SEVERAL VIEWS OF THE FIGURES

FIG. 1 is a top perspective view of an exemplary nonwoven according to the present invention.

FIG. 2 is a top view of the nonwoven of FIG. 1.

The subject of the invention will be explained in more detail with the aid of exemplary embodiments.

### DETAILED DESCRIPTION OF THE PREFERRED EMBODIMENTS

Staple fibers are used as fibers with an essentially round cross-section. The production of the nonwoven takes place via a dry laying method, in particular, with a carding machine, and via a mechanical consolidation, especially via a needling step. Subsequently, there is an impregnation and drying or only a thermal consolidation. Thus, nonwovens with a weight of 50-300 g/m² are produced with a maximum tensile force in at least one direction of 100-300 N/50 mm. The water absorption capacity is 2- to 10-fold of the nonwoven weight.

The approximately 0.7- to 1.5-mm-thick nonwoven is subsequently structured in a further process. To this end, the nonwoven is heated with radiation heat, contactless, to temperatures between 100 and 240° C. The structuring takes place continuously by deep-drawing in a tempered embossing calender. The material can thereby be held laterally. The structure of the nonwoven formed has a thickness of 2-6 mm.

The 3-dimensional structure produced in such a manner has so-called pick-up pores or cavities, which are particularly suitable for taking up dirt. Furthermore, the three-dimensional structure is mechanically particularly stable. The weight, the water absorption capacity and the tensile force are not substantially changed by the structuring, and the softness of the nonwoven is also retained.

Production of the binder-bound nonwovens can be as follows. A staple fiber mixture of viscose and/or cotton fibers and synthetic fibers, wherein the synthetic fraction is 10-40 wt %, preferably, 30-40 wt %, is loosened up by means of one to three carding machines, and a fiber web is formed. The web cross-laying machine placed after the carding removes the web formed by the carding machines and layers it in several layers over one another to form one nonwoven.

The first consolidation of the nonwoven to form a needle-punched nonwoven is carried out with one to three needling machines from both sides of the nonwoven.

After the needling, the nonwoven is impregnated for additional consolidation. To this end, there is an application with a foamed binding fluid. The binding fluid contains NBR latex and perhaps auxiliaries. The foam is dosed in the crotch of a padding machine, and the excess liquid is squeezed out on a roller pair. Thus, with a binding fluid that contains approximately 6 wt % NBR latex, approximately 15% solids relative to the total weight are applied.

Following the impregnation, there is a drying of the nonwoven and a crosslinking of the binder. For the drying and crosslinking, suspension driers and/or cylinder drying machines are used. Temperatures of 160-200° C. are used.

The nonwoven is subsequently structured in another process as described above.

It is surprising that a binder-bound nonwoven, whose binder is not a thermoplastic material, can be re-shaped in a thermally stable manner at all.

Thus, a nonwoven with a thickness of 2-6 mm is produced with a weight of somewhat more than 100 g/m² with a maximum tensile force in at least one direction of at least 100 N/50 mm. A solids content of binder brings about a special structural stability, which nevertheless still has sufficient softness. The water absorbency is 6- to 9-fold the nonwoven weight.

For the binder-bound nonwoven, in accordance with the data of the table, a fiber mixture of:

61 wt % viscose,

24 wt % polyethylene terephthalate (PET),

15 wt % polypropylene (PP),

which is impregnated with 6 wt % nitrile butadiene rubber (NBR) latex and whose solids content is 15 wt %, was used. The impregnation perhaps contains, moreover, at least one dye, dependent on the desired coloring and the need.

Production of the bicomponent nonwovens is as follows. A staple fiber mixture of viscose and/or cotton fibers and synthetic fibers and core-jacket bicomponent fibers of a higher-melting core and lower-melting jacket is loosened by means of one to three cardings, and a fiber web is formed. The web cross-laying machine placed after the carding accepts the web formed by the carding and layers this in several layers, one over the other, to form a nonwoven.

The first consolidation of the nonwoven to form a needle-punched nonwoven takes place with one to three needling machines from both sides of the nonwoven.

After the needling machines, a thermofixing of the nonwoven is carried out. First, it moves into a thermofusioning. Temperatures up to 200° C. are used in the perforated belt unit heated with hot air. By the melting of the adhesive fibers, the stability of the nonwoven is increased. After the thermofusioning, a so-called thermobonding takes place in which a thermal consolidation is carried out by a heated calender. By means of the high pressure and temperatures up to 250° C. in the calender slit, the nonwoven is compressed, and the fibers are bound, especially, via the lower-melting jacket fibers.

The bicomponent nonwoven can be thermally re-formed and is structured in a further process as described above, wherein, in particular, the core and jacket fibers are shaped.

A nonwoven with a thickness of 2-6 mm is produced with a weight of 100-200 g/m², with a maximum tensile force in at least one direction of 100-200 N/50 mm, which consequently has special mechanical structure stability, and which, moreover, is also sufficiently soft. The water absorptive capacity is 6- to 9-fold the nonwoven weight.

For the bi-component nonwoven, in accordance with the data of the table, a fiber mixture of:
20 wt % core-jacket bicomponent fibers,
consisting of a polyethylene terephthalate core with a melting temperature of 263° C. and a co-polyethylene terephthalate jacket with a melting temperature of 160° C.,
65 wt % viscose, and
15 wt % polypropylene (PP) was used.

Production of the sandwich nonwovens is as follows. A staple fiber mixture for an inside layer consisting of more than 50 wt % plastic fibers and a staple fiber mixture for the outside layers consisting of more than 50 wt % viscose and/or cotton fibers is loosened up for a three-layer sandwich nonwoven by means of three cardings, and a fiber web is formed. The web cross-laying machine placed after the carding accepts the web formed by the carding and layers it in several layers, one over the other, to form a nonwoven.

Cardings one and three are responsible for the outside layers of the nonwoven. Carding two is responsible for the middle layer of the nonwoven.

The first consolidation of the nonwoven to form a needle-punched nonwoven is carried out with one to three needling machines from both sides of the nonwoven.

After the needling machines, a thermofixing of the nonwoven takes place. First, it moves into a thermofusioning. Temperatures up to 200° C. are used in the perforated belt unit heated with hot air. By the melting of the adhesive fibers, the stability of the nonwoven is thus increased. After the thermofusioning, a so-called thermobonding takes place, in which a thermal consolidation is carried out by a heated calender. By means of the high pressure and temperatures up to 250° C. in the calender slit, the nonwoven is compressed, and the fibers are bound. In this way, the nonwoven essentially obtains its strength.

The nonwoven is subsequently structured in a further process as described above.

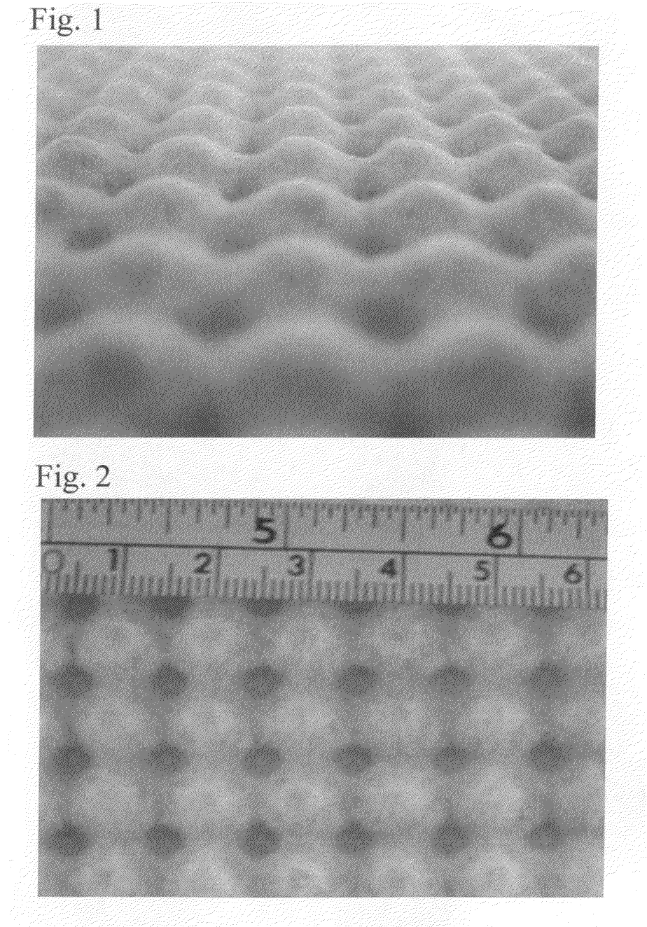

FIGS. 1 and 2 illustrate the structure of an exemplary nonwoven. The photographs shown therein were taken by a Canon Powershot G2 (4 Mega Pixel) camera. FIG. 1 shows a lateral top view, and FIG. 2 shows a direct top view of the surface structure of the sandwich nonwoven.

The special combination of the material and structural composition leads to a special mechanical stability of the product, with the retention of softness and the particularly good water absorptive capacity.

Thus, a nonwoven with a thickness of 2-6 mm and with a weight of approximately 200 g/m² is produced, with a maximum tensile force in at least one direction of approximately 200-250 N/50 mm. The flat fabric thereby has a weight of 40-60 g/m² for an inside layer and per outside layer, a weight of 40-80 g/m². The water absorptive capacity is 3- to 7-fold the nonwoven weight.

For the three-layer sandwich nonwoven, in accordance with the data of the table, a fiber mixture consisting of 15 wt % polypropylene (PP) and 85 wt % viscose for each outside layer and 50 wt % polypropylene (PP) and 50 wt % polyethylene terephthalate (PET) for the inside layer was used.

TABLE

| | (1)Binder-bound | (2)Bicomponent | (3)Sandwich |
|---|---|---|---|
| | nonwoven (average | nonwoven (average | nonwoven (average |
| | values) | values) | values) |
| Thickness (mm) | 3.6 | 5.0 | 5 |
| Weight (g/m²) | 105 | 170 | 208 |
| Water absorption dry (%) | 860 | 932 | 640 |
| Water absorption moist | 646 | 627 | 348 |
| (%) | | | |
| Maximum tensile force | 105 | 176 | 250 |
| length (N/50 mm) | | | |
| Maximum tensile force | 100 | 131 | 204 |
| transverse N/50 mm) | | | |
| Maximum tensile force | 30 | 29 | 32 |
| elongation length (%) | | | |
| Maximum tensile force | 60 | 58 | 42 |
| elongation transverse (%) | | | |
| Pre-shrinkage, length (%) | 9 | 4 | 4 |
| based on ISO 3759 | | | |
| Pre-shrinkage, transverse | 5 | 3 | 2 |
| (%) based on ISO 3759 | | | |
| Thickness after washing | 1.8 | 4 | 3 |
| at 60° C. and drying [mm] | | | |
| based on ISO 3759 | | | |

Samples were punched out (size DIN A4, 210×297 mm) from each nonwoven, and the samples are washed in a Miele washing machine (Miele Novotronic® W 725 or Miele Softtronic Vitality® W 400) at 60° C. (program: Laundry to be boiled/colored wash; spin: 1200 rpm) with Persil® and subsequently dried in a Miele drier (program: extra dry). After the drying, the length and width of the samples are measured.

As the aforementioned data show, the cleaning articles in accordance with the invention are wash-stable at temperatures up to 60° C.

1. A cleaning article for moist or wet cleaning comprising:
a nonwoven with a mechanically stable three-dimensional structure, a weight per unit area of 50-300 g/m² and a thickness of 2-6 mm;
wherein the nonwoven is consolidated mechanically, chemically or thermally;
wherein the nonwoven has a maximum tensile force, in at least one direction, of 100-300 N/50 mm, a maximum tensile force elongation in a longitudinal direction of, at most, 35% and in a transverse direction of, at most, 70%, a water absorptive capacity of 2- to 10-times a weight of the nonwoven;
wherein the nonwoven is soft, has a three-dimensional structure with a plurality of cavities; and
wherein the nonwoven is a binder-bound nonwoven comprising a fiber mixture of 20-90 wt % cotton and/or viscose fibers, 5-50 wt % polyester fibers or 5-35 wt % polypropylene fibers, and is impregnated with 2-20 wt % of a polymeric binder selected from latex suspensions whose solids fraction is 1-60 wt %.

2. The cleaning article according to claim 1, wherein the nonwoven is made of staple fibers that are dry-laid and the nonwoven is consolidated mechanically by means of needling and is structured three-dimensionally by deep-drawing in an embossing calender.

3. The cleaning article according to claim 1, wherein the nonwoven is made of staple fibers that are dry-laid and the nonwoven is consolidated thermally and is structured three-dimensionally by deep-drawing in an embossing calender.

4. The cleaning article according to claim 1, wherein the nonwoven is made of staple fibers that are dry-laid and the nonwoven is consolidated chemically by means of a binder and is structured three-dimensionally by deep-drawing in an embossing calender.

5. The cleaning article according to claim 1, wherein the binder in the binder-bound nonwoven is selected from nitrile butadiene rubber (NBR) latex suspensions.

6. The cleaning article according to claim 1, wherein the binder-bound nonwoven comprises 60-65 wt % viscose fibers, 20-30 wt % polyethylene terephthalate fibers, or 10-20 wt % polypropylene fibers and is impregnated with NBR latex as a binder, whose solids fraction is 10-20 wt %.

7. The cleaning article according to claim 1, wherein in the nonwoven is wash-stable at temperatures up to 60° C.

8. A method of using the cleaning article according to claim 1 to clean a surface.

9. A method of using the cleaning article according to claim 1 as a cleaning cloth.

10. A method of using the cleaning article according to claim 1 in a wiping mop.

11. A cleaning article for moist or wet cleaning comprising:
a nonwoven with a mechanically stable three-dimensional structure, a weight per unit area of 50-300 g/m² and a thickness of 2-6 mm;
wherein the nonwoven is consolidated mechanically, chemically or thermally;
wherein the nonwoven has a maximum tensile force, in at least one direction, of 100-300 N/50 mm, a maximum tensile force elongation in a longitudinal direction of, at most, 35% and in a transverse direction of, at most, 70%, a water absorptive capacity of 2- to 10-times a weight of the nonwoven;
wherein the nonwoven is soft, has a three-dimensional structure with a plurality of cavities; and
wherein the nonwoven is a bi-component nonwoven comprising a fiber mixture of 5-50 wt % bi-component core-jacket fibers, 20-90 wt % cotton and/or viscose fibers or 5-50 wt % polypropylene fibers.

12. The cleaning article according to claim 11, wherein the nonwoven is made of staple fibers that are dry-laid and the nonwoven is consolidated mechanically by means of needling and is structured three-dimensionally by deep-drawing in an embossing calender.

13. The cleaning article according to claim 11, wherein the nonwoven is made of staple fibers that are dry-laid and the nonwoven is consolidated thermally and is structured three-dimensionally by deep-drawing in an embossing calender.

14. The cleaning article according to claim 11, wherein the nonwoven is made of staple fibers that are dry-laid and the nonwoven is consolidated chemically by means of a binder and is structured three-dimensionally by deep-drawing in an embossing calender.

15. The cleaning article according to claim 1, wherein the bi-component-nonwoven comprises bi-component core-jacket fibers made of 15-20 wt % polyethylene terephthalate, 60-70 wt % viscose fibers and 10-20 wt % polypropylene fibers.

16. The cleaning article according to claim 11, wherein in the nonwoven is wash-stable at temperatures up to 60° C.

17. A method of using the cleaning article according to claim 11 to clean a surface.

18. A method of using the cleaning article according to claim 11 as a cleaning cloth.

19. A method of using the cleaning article according to claim 11 in a wiping mop.

20. A cleaning article for moist or wet cleaning comprising:
a nonwoven with a mechanically stable three-dimensional structure, a weight per unit area of 50-300 g/m² and a thickness of 2-6 mm;
wherein the nonwoven is consolidated mechanically, chemically or thermally;
wherein the nonwoven has a maximum tensile force, in at least one direction, of 100-300 N/50 mm, a maximum tensile force elongation in a longitudinal direction of, at most, 35% and in a transverse direction of, at most, 70%, a water absorptive capacity of 2- to 10-times a weight of the nonwoven;
wherein the nonwoven is soft, has a three-dimensional structure with a plurality of cavities; and
wherein the nonwoven is a sandwich nonwoven structured with at least three layers, wherein at least one inside layer is structured to be equal to or more than 50 wt % plastic fibers and the outside layers are structured by more than 50 wt % cotton and/or viscose fibers.

21. The cleaning article according to claim 20, wherein the sandwich nonwoven is impregnated with 2-20 wt % of a polymeric binder selected from latex suspensions whose solids fraction is 1-60 wt %, preferably, 5-20 wt %.

22. The cleaning article according to claim 20, wherein the nonwoven is made of staple fibers that are dry-laid and the nonwoven is consolidated mechanically by means of needling and is structured three-dimensionally by deep-drawing in an embossing calender.

23. The cleaning article according to claim 20, wherein the nonwoven is made of staple fibers that are dry-laid and the nonwoven is consolidated thermally and is structured three-dimensionally by deep-drawing in an embossing calender.

24. The cleaning article according to claim 20, wherein the nonwoven is made of staple fibers that are dry-laid and the nonwoven is consolidated chemically by means of a binder and is structured three-dimensionally by deep-drawing in an embossing calender.

25. The cleaning article according to claim 20, wherein the plastic fibers in the sandwich nonwoven are selected from the group consisting of polyolefins, polyesters, polyacrylonitriles, polyamides, polyimides, polycarbonates, copolymers thereof and mixtures thereof.

26. The cleaning article according to claim 20, wherein the least one inside layer of the sandwich nonwoven is structured by 30-70 wt % polypropylene fibers and by 70-30 wt % polyethylene terephthalate fibers and wherein the outside layers are structured to be equal to or more than 85 wt % viscose fibers and equal to or less than 15 wt % polypropylene fibers.

27. The cleaning article according to claim 20, wherein the least one inside layer of the sandwich nonwoven is structured by 30-40 wt % polypropylene fibers, 25-50 wt % polyethylene terephthalate fibers and by 20-30 wt % viscose fibers and wherein the outside layers are structured to be equal to or more than 85 wt % viscose fibers and equal to or less than 15 wt % polypropylene fibers.

28. The cleaning article according to claim 20, wherein in the nonwoven is wash-stable at temperatures up to 60° C.

29. A method of using the cleaning article according to claim 20 to clean a surface.

30. A method of using the cleaning article according to claim 20 as a cleaning cloth.

31. A method of using the cleaning article according to claim 20 in a wiping mop.
